(19) United States
(12) Patent Application Publication
(10) Pub. No.: US 2005/0198370 A1
(43) Pub. Date: Sep. 8, 2005

(54) Method for creating, deleting, and maintaining logical networks

(75) Inventors: Michael J. Miller, Pleasant Grove, UT (US); Lyman D. Horne, Salt Lake City, UT (US); W. Paul Willes, Alpine, UT (US); Douglas M. Grove, Elk Ridge, UT (US)

Correspondence Address: Lloyd W. Sadler;Snell & Wilmer, LLP, Suite 1200, 15 West South Temple, Salt Lake City, UT, 84101, US

(73) Assignee: Phonex Broadband Corporation, Midvale, UT (US)

(21) Appl. No.: 10/770,061

(22) Filed: Feb. 1, 2004

(51) Int. Cl. G06F 15/173

(52) U.S. Cl. 709/238

(57) ABSTRACT

A system and method for creating, deleting, and maintaining logical networks based on the needs of a network. Logical networks are created on a physical network and can be encrypted to further isolate the logical networks. Logical network addresses are maintained for network nodes and aged based on responses from network nodes. Network nodes can be detected and added to additional logical networks based on network or users needs. Network nodes can be added or removed on a as needs basis. Additionally, logical networks can be removed based on system needs.

### BACKGROUND OF INVENTION

1. Field of the Invention

This invention relates to electronic communications systems. More specifically, this invention relates to creating multiple networks within an electronic communications system.

2. Description of Related Art

A variety of communication systems use methods and systems for creating networks. Typically, such approaches only create a single network on the same physical medium. However, these methods are typically not designed to meet the requirements of power line and wireless networks which require separate secure networks which share the same physical medium. Although these references may not constitute prior art, For general background material, the reader is directed to the following United States Patents and Patent Applications, each of which is hereby incorporated by reference in its entirety for the material contained therein: U.S. patent and Patent Application Nos.: 2003/0009546, 2002/0048368, 2002/0087666, 2002/0032780, U.S. Pat. Nos. 6,477,436, 6,311,208, 6,252,884, 6,212,559, 6,185,213, 6,014,753, 6,078,575, 5,835,710, 5,583,860, 5,557,748.

### SUMMARY OF INVENTION

It is desirable to provide a method and system for creating, deleting and maintaining logical networks within a physical network.

Therefore it is a general object of this invention to provide a system and method for creating logical networks.

It is a further object of an embodiment of this invention to provide a system and method for creating encrypted logical networks.

It is a further object of an embodiment of this invention to provide a system and method to create logical networks using a network name and network number.

It is a further object of an embodiment of this invention to provide a system and method to create a logical network and an active channel.

It is a further object of an embodiment of this invention to provide a system and method to create multiple logical networks on the same physical network.

It is a further object of an embodiment of this invention to provide a system and method to assign logical addresses to nodes on a physical and logical network.

It is a further object of an embodiment of this invention to provide a system and method to assign logical addresses and create an active channel.

It is a further object of an embodiment of this invention to provide a system and method to age logical addresses for reuse within the logical network.

It is a further object of an embodiment of this invention to provide a system and method to age logical addresses for reuse within the logical network and create an active channel.

It is a further object of an embodiment of this invention to provide a system and method for adding network nodes to a logical network.

It is a further object of an embodiment of this invention to provide a system and method for adding network nodes to a logical network that is encrypted.

It is a further object of an embodiment of this invention to provide a system and method for adding network nodes to a logical network and create an active channel.

It is a further object of an embodiment of this invention to provide a system and method for deleting network nodes from a logical network.

It is a further object of an embodiment of this invention to provide a system and method for deleting network nodes from a logical network which is encrypted.

It is a further object of an embodiment of this invention to provide a system and method for deleting network nodes from a logical network and create an active channel.

It is a further object of an embodiment of this invention to provide a system and method to delete one or more logical networks.

It is a further object of an embodiment of this invention to provide a system and method to detect network nodes that are not part of a logical network.

It is a further object of an embodiment of this invention to provide a system and method to detect network nodes that are not part of a logical network and create an active channel.

It is a further object of an embodiment of this invention to provide a system and method for network nodes to announce their presence on the network so the network nodes can be added to one or more logical networks.

It is a further object of an embodiment of this invention to provide a system and method to create all the embodiments of this invention on a power line network, a wireless network, a light frequency network, an acoustic network, and a wired network.

These and other objects of this invention will be readily apparent to those of ordinary skill in the art upon review of the following drawings, detailed description, and claims. In the present preferred embodiment of this invention, the logical network systems and methods make use of novel logical network creation, deletion, address management and notification processes.

### BRIEF DESCRIPTION OF DRAWINGS

In order to show the manner that the above recited and other advantages and objects of the invention are obtained, a more particular description of the present preferred embodiments of this invention, which are illustrated in the appended drawings, are described as follows. The reader should understand that the drawings depict only present preferred and best mode embodiments of the invention, and are not to be considered as limiting in scope. A brief description of the drawings is as follows:

FIG. 1a is a diagram of the present preferred packet structures used by this invention.

FIG. 1b is a diagram of the present preferred physical and logical network.

FIG. 1c is a flow diagram of the present preferred process for creating a logical network.

FIG. 2 is a flow diagram of the present preferred process for getting a logical address from a bandwidth master control node.

FIG. 3 is a flow diagram of the present preferred process for aging logical addresses.

FIG. 4 is a flow diagram of the present preferred process for adding a network node to a logical network from a network node that is part of the logical network.

FIG. 5 is a flow diagram of the present preferred process of a network node being added to a logical network.

FIG. 6 is a flow diagram of the present preferred process for a network node removing another network node from a logical network.

FIG. 7 is a flow diagram of the present preferred process for a network node being removed from a logical network.

FIG. 8 is a flow diagram of the present preferred process for deleting a logical network.

FIG. 9 is a flow diagram of the present preferred process for a network node announcing itself so the network node can be added to a logical network.

FIG. 10 is a flow diagram of the present preferred process for discovering network nodes which are not assigned to a specific logical network.

FIG. 11 is a diagram of the present preferred network for sending data segments between network nodes.

FIG. 12 is a diagram of the Time Division Multiplexed structure of the present preferred embodiment of this invention used to transfer data on a network.

FIG. 13 is a flow diagram of the present preferred virtual channel creation process from the node which is requesting to create a virtual channel.

FIG. 14 is a flow diagram of the present preferred virtual channel creation process from the node which is being requested to be apart of the virtual channel.

FIG. 15 is a flow diagram of the present preferred virtual channel removal process once a virtual channel is created.

FIG. 16 is a flow diagram of the present preferred control node active channel creation process.

FIG. 17 is a flow diagram of the present preferred channel creation process for a peer active channel.

FIG. 18 is a diagram of the present preferred dynamic active channel resizing.

FIG. 19 is a flow diagram of the present preferred process for bandwidth allocation using channel priorities.

FIG. 20 is a flow diagram of the present preferred process for bandwidth reclamation in a control node active channel.

FIG. 21 is a flow diagram of the present preferred process for notifying network nodes that the network node is no longer part of an active channel.

FIG. 22 is a diagram of the present preferred process for bandwidth reclamation in a peer active channel.

Reference will now be made in detail to the present preferred embodiment of the invention, examples of which are illustrated in the accompanying drawings.

### DETAILED DESCRIPTION

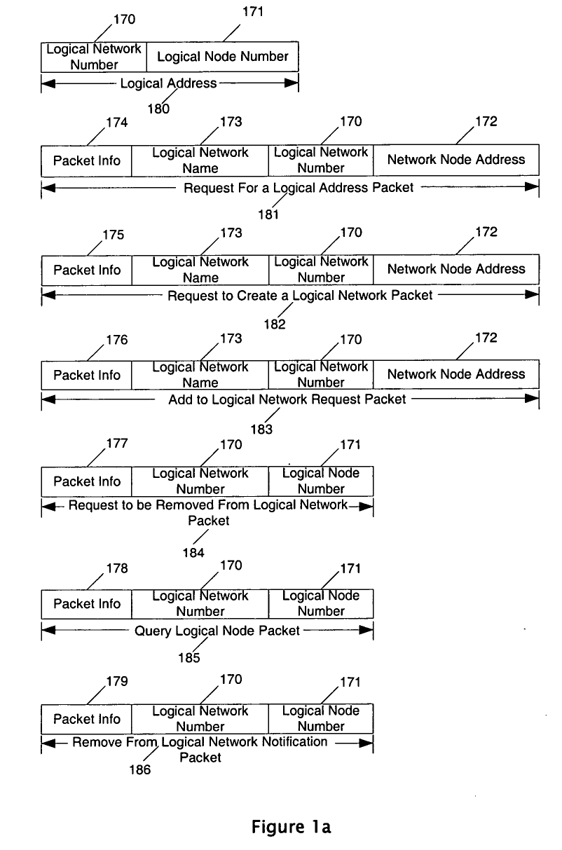

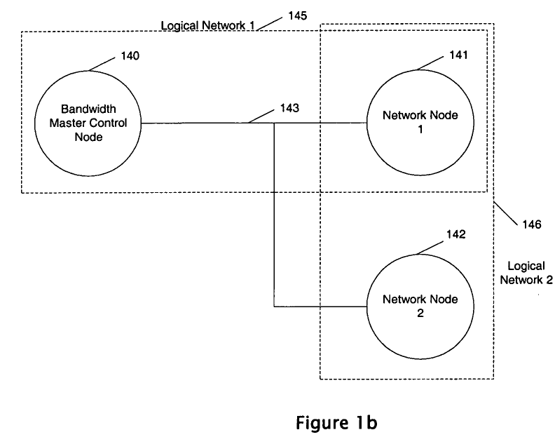

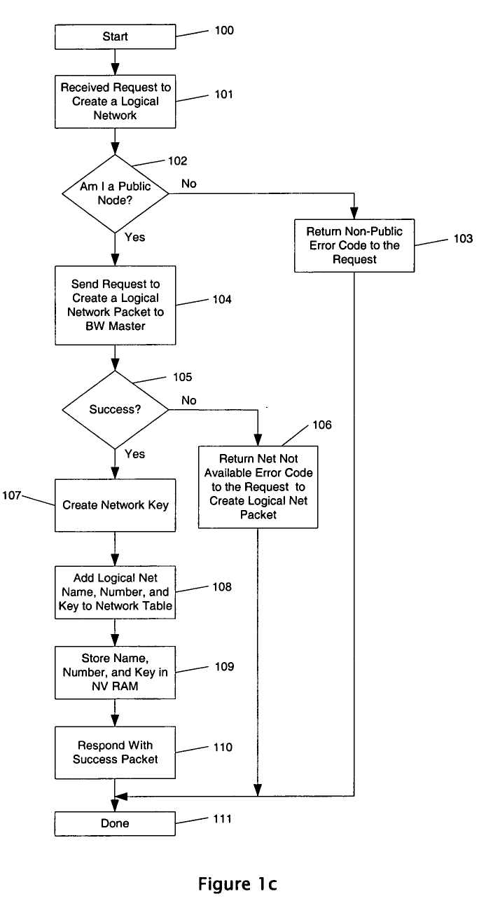

FIG. 1a is a diagram of the present preferred packet structures used by this invention. In this document when referring to a network node in the singular, while referencing the single node with multiple node numbers (i.e. 140-142) indicates that all referenced network nodes can perform the same function as a single network node. The same is true when referencing a logical network in the singular while referencing the single logical network with multiple logical network numbers (i.e. 145-146). A logical address 180 comprises a logical network number 170 and a logical node number 171. A logical address 180 is used to uniquely identify a network node 140-142 on a logical network 145-146. The logical node number 171 is used to uniquely identify a network node 140-142 on a logical network 145-146 and the logical network number 170 is used to identify a specific logical network 145-146. The network node 140-142 receives a logical address 180 once the network node 140-142 is added to a logical network 145-146. When a network node 140-142 receives a logical address 180 and communicates using the logical address 180 with other network nodes 140-142 on a logical network, it is called private addressing. Before a network node 140-142 receives a logical address 180, the network node 140-142 communicates using public addressing which comprises a network node address 172 and a logical network number 170 of zero. The network node address 172 is a unique number for the network node 140-142. A logical network number 170 of zero indicates that the network node 140-142 is using public addressing and that a network node address 172 is included in the packet. In the present preferred embodiment, the logical network number 170 is three bits, the logical node number 171 is 8 bits and the network node address 172 is 12 bits long but the size of these three fields can vary based on system requirements. Also, a logical network number 170 other than zero can be used as the public network number as long as the public network number is unique. A logical address 180 is used because the logical address 180 requires less overhead than with public addressing. A request for logical address packet 181 is used by a network node 140-142 to get a logical address 180 after the network node 140-142 has joined a logical network 145-146. A network node 140-142 uses a request for logical address packet 181 using public addressing. The request for logical address packet 181 comprises a packet information field 174 which is used to uniquely identify the request for logical address packet 181, a logical network name 173 which is a text string that identifies the logical network 145-146, a logical network number 170, and a network node address 172. A request to create a logical network packet 182 comprises a packet information field 175 which uniquely identifies the request to create a logical network packet 182, a logical network name 173, a logical network number 170, and a network node address 172. The request to create a logical network packet 182 is sent by a network node 140-142 when a logical network 145-146 needs to be created. The add to logical network request packet 183 comprises a packet information field 176 which uniquely identifies the add to logical network request packet 183, a logical network name 173, a logical network number 170, and a network node address 172. The add to logical network request packet 183 is used to add a network node 140-142 to a logical network 145-146 once the logical network 145-146 has been created. The request to be removed from logical network packet 184 is sent by a network node 140-142 to network node 140-142 to remove a network node 140-142 from a logical network 145-146. The request to be removed from a logical network packet 184 comprises a packet information field 177 which uniquely identifies the request to be removed from a logical network packet 184, a logical network number 170, and a logical node number 171. The remove from logical network notification packet 186 is sent by a network node 140-142 to a bandwidth master control node 140 when a network node 140-142 is removed from a logical network 145-146. The remove from logical network notification packet 186 comprises a packet information field 179 which uniquely identifies the remove from logical network notification packet 186, a logical network number 170, and logical node number 171. The query logical node packet 185 used to query network nodes 140-142 to see if the network nodes 140-142 are still active on the logical network 145-146. The query logical node packet 185 comprises a packet information field 179 which uniquely identifies the query logical node packet 185, a logical network number 170, and logical node number 171.

FIG. 1b is a diagram of the present preferred physical 143 and logical network 145-146. A logical network 145-146 is created by one or more network nodes 140-142 which are connected by a physical network 143. FIG. 1b shows three network nodes 140-142 which are connected together by a physical network 143. The physical network 143 has been divided up into two logical networks 145 and 146. Logical network one 145 comprises two network nodes 140 and 141. Logical network two 146 comprises two network nodes 141 and 142. Network nodes 140-142 communicate on a logical network 145-146 using a logical address 180. In FIG. 1b, network node one 141 communicates with the bandwidth master control node 140 (which is also a network node) using a logical address 180 which contains a unique logical network number 170. Network node one 141 communicates with network node two 142 using a different logical address 180 and different logical network number 170. Each logical network 145-146 can be encrypted using a different encryption key for each logical network 145-146 thus providing security for each logical network 145-146.

FIG. 1c is a flow diagram of the present preferred process for creating a logical network 145-146. The process for creating a logical network 145-146 starts 100 when a network node 140-142 receives 101 a request to create a logical network 140-142. The request can be initiated from a user interface or a software application and the like. The network node 140-142 determines 102 if the network node 140-142 can be public. Some network nodes 140-142 may only be able to support one logical network 145-146 while others may be able to support multiple logical networks 145-146. If a network node 140-142 can only support one logical network 145-146 the network node 140-142 will not be public once the network node 140-142 is added to a logical network 145-146. If in test 102 the network node 140-142 is not public a non public error code is returned 103 to the user, application or the like and the process is done 111. If test 102 is yes, the network node 140-142 where the request to create a logical network sends 104 a request to create a logical network packet 182 to the bandwidth master control node 140. If the bandwidth master control node 140 responds with success 105 to the network node 140-142 which sent the request to create a logical network packet 182 in step 104, a network key is created 107 to encrypt the logical network 145-146. If test 105 is not successful, an error code network not available is returned 106 by the bandwidth master control node 140 to the network node 140-142 which originated the request in step 101 and the process completes 111. After creating the encryption key 107, the logical network name 173, logical network number 171, and the encryption key for the logical network 145-146 are added 108 to a table for use later. The logical network name 173, logical network number 171, and the encryption key for the logical network 145-146 are stored 109 in non-volatile random access memory. A response is sent 110 to the network node 140-142 that made the original request in step 101 indicating that the new logical network 145-146 has been created successfully and the process is complete 111.

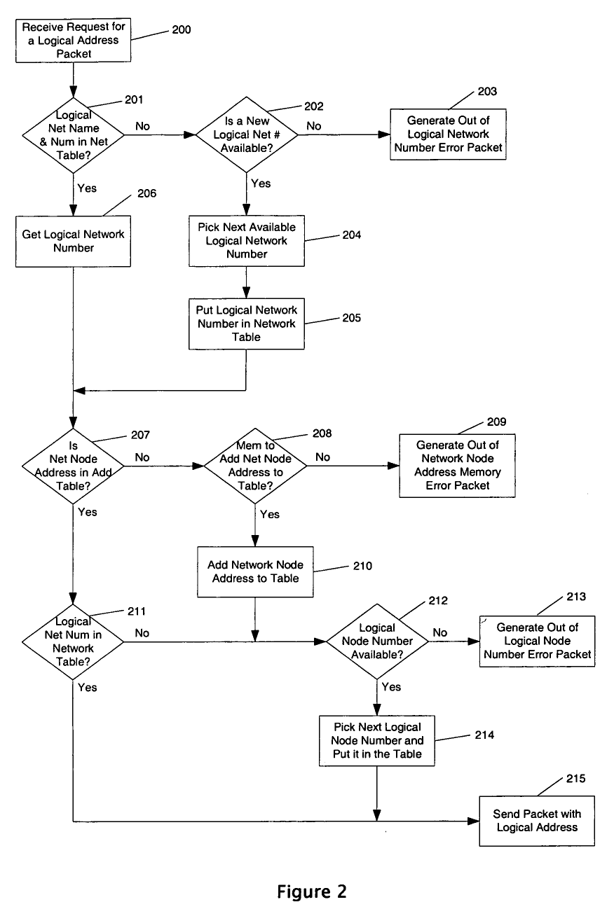

FIG. 2 is a flow diagram of the present preferred process for getting a logical address 180 from a bandwidth master control node 140. The bandwidth master control node keeps a table for tracking logical addresses 180 and a table which shows which network nodes 140-142 are using a specific logical address 180. The two tables are a network table which contains the logical network name 173 and the logical node number 171 and the address table which contains the network node address 172 associated with a logical network name 173 and a logical network number 170 in the network table. The process begins 200 when a request for a logical address packet 181 is received by the bandwidth master control node 140. The bandwidth master control node 140 checks 201 to see if the logical network name 173 and the logical network number 170 are in the bandwidth master control node's network table. If the logical network name 173 and logical network number 170 are not in the table, the bandwidth master control node 140 checks 202 to see if a new logical network number 170 is available. If not, a logical network number error response packet is sent in response to the request for a logical address packet 181 received in step 200. Otherwise, the next available logical network number 170 is picked 204 and put 205 into the network table. The process flows to test 207. If in test 201 the logical network name 173 and logical network number 170 are in the network table the bandwidth master control node 140 gets 206 the logical network number 170. Test 207 checks to see if the network node address 172 is in the address table. If not, the bandwidth master control node 140 checks 208 to see if there is enough memory to add the network node address 172 to the address table. If not, the bandwidth master control node 140 generates an out of logical number error packet in response to the request for logical address packet 181 received in step 200. Otherwise, the network node address 172 is added 210 to the address table and the process flows to step 212. If in test 207 the network node address 172 is in the address table, the process checks 211 to see if the logical network number 173 is in the network table. If so, a response packet containing a logical address 180 is sent 215 in response to the request for logical address packet 181 received in step 200. Otherwise, test 212 checks to see if a logical node number 171 is available. If not, an out of logical node number error packet is sent 213 in response to the request for logical address packet 181 received in step 200. Otherwise, the next logical address 180 is picked 214 and put into the address table. A response packet containing a logical address 180 is sent 215 in response to the request for logical address packet 181 received in step 200.

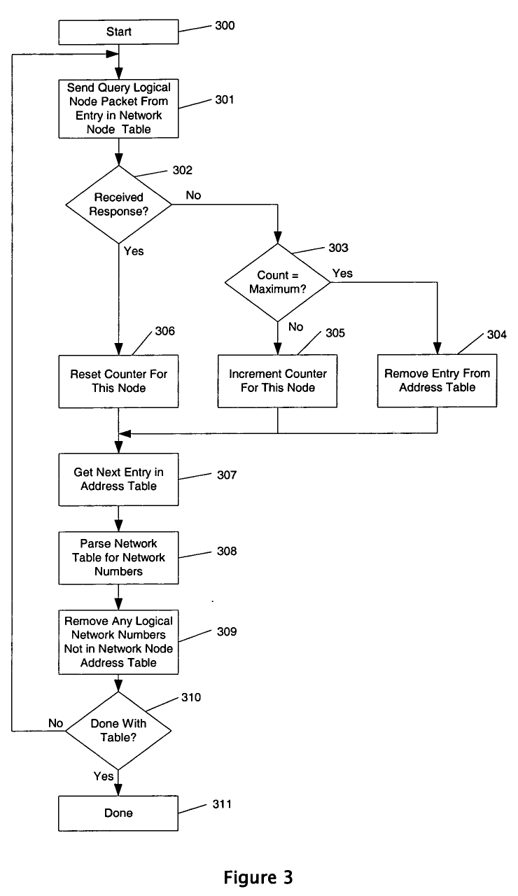

FIG. 3 is a flow diagram of the present preferred process for aging logical addresses 180. As network nodes 140-142 come and go on a logical network 145-146 there is a need to age logical addresses 180 for reuse within the logical network 145-146. Network nodes 140-142 within a logical network 145-146 are queried and a count is kept for how many times the network node 140-142 does not respond. The process starts 300 and a network node 140-142 which is responsible for aging logical addresses 180 (which is typically the bandwidth master control node 140) sends 301 a query logical node packet 185 to a network node 140-142 which is in the network table. If a response to the query logical node packet 185 is received 302 within a time period, the process resets a counter associated with the network node 140-142 and flows to step 307. Otherwise, the process checks to see if the count for the network node 140-142 is at the maximum value 303. If so, the network node address 172 is removed 304 from the address table and the process flows to step 307. Otherwise, the counter for the network node 140-142 is incremented 305 and the process flows to step 307. Step 307 gets the next network node address 172 in the address table. The process parses 308 the network table for any logical network numbers 170 not associated with a network node address 172. The process removes 309 any logical network numbers 170 which do not have an associated network node address 172. The process checks 310 to see if the process has completed searching the table. If not, the process sends 301 a query logical node packet 185 to the next node in the address table. Otherwise, the process is done 311.

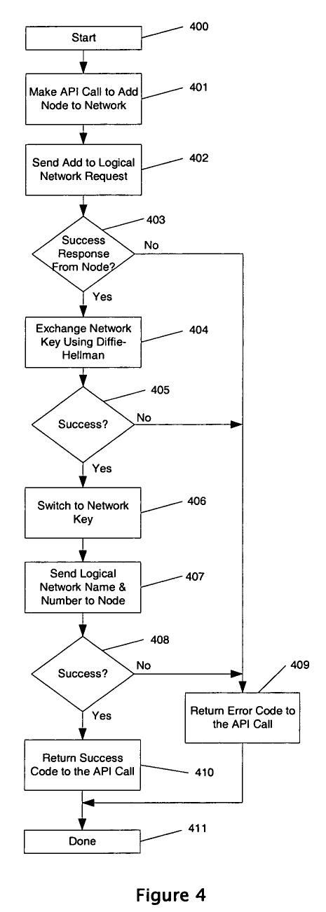

FIG. 4 is a flow diagram of the present preferred process for adding a network node 140-142 to a logical network 145-146 from a network node 140-142 that is part of a logical network 145-146. The process begins in step 400 when an Application Programming Interface (API) call 401 is made on a network node 140-142 which is part of a logical network 145-146. An add to logical network request 183 is sent 402 to the network node 140-143 which is not part of the logical network 145-146. If a successful response is not received 403 from the network node 140-142 being added to the logical network 145-146, an error code is returned 409 to the API call in step 401 and the process is complete 411. If a successful response is received in test 403, the network node 140-143 which is part of the logical network 145-146 exchanges 404 a network encryption key to the network node 140-142 being added to the logical network 145-146. The present preferred embodiment uses Diffie-Hellman key exchange, but this process can work with any encryption key exchange mechanism. If the encryption key exchange was not successful 405, an error code is returned to the API call in step 401 and the process completes 411. Otherwise, if test 405 is successful, the network node 140-142 switches 406 to the new encryption key when communicating with the network node 140-142 which is being added to the logical network 145-146. The logical network name 173 and the logical network number 170 are sent 407 to the network node 140-142 which is being added to the logical network 145-146. If the logical network name 173 and the logical network number 170 were successfully sent 408, a success code is returned 410 to the API call made in step 401 and the process completes 411. Otherwise, an error code is returned 409 to the API call made in step 401 and the process completes 411.

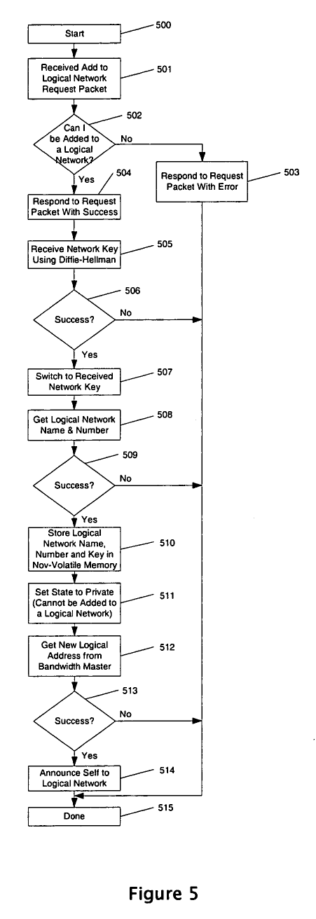

FIG. 5 is a flow diagram of the present preferred process of a network node 140-142 being added to a logical network 145-146. The process begins 500 when the network node 140-142 which is being added to a logical network 145-146 receives 501 an add to logical network request packet 183 which is sent in step 402. The process checks 502 to see if the network node 140-142 can be added to the logical network 145-146. Reasons a network node 140-142 cannot be added to a logical network 145-146 can be that the network node 140-142 is already part of a logical network 145-146 and cannot be added to a second logical network 145-146 and the like. If the network node 140-142 cannot be added to the logical network 145-146 in test 502, the network node 140-142 responds 503 with an error packet in response to the request to create a logical network packet 182 received in step 501 and completes 515. Otherwise, the network node 140-142 responds 504 with a success packet in response to the add to logical network packet received in step 501. The network node 140-142 waits to receive 505 the encryption key exchanged from step 404 from the network node 140-142 which is already part of the logical network 145-146. If the encryption key is not exchanged successfully 506, the process completes 515. Otherwise, the network node 140-142 switches 507 to the new encryption key. The network node 140-142 gets 508 the logical network number 170 and the logical network name 173 from step 407. If step 508 is not successful 509, the process completes 515. Otherwise, the network node 140-142 stores 510 the logical network name 173, the logical network number 170, and the encryption key in non-volatile memory. The network node 140-142 sets 511 the network node's 140-142 state to private. A network node 140-142 can be set to public again and added to a second logical network 145-146 if that capability is supported. In FIG. 1b, network node 141 has been added to two logical networks 145-146 while network node 140 is only part of logical network one 145 and network node 142 is part of logical network two 146. The process gets 512 a new logical address 180 from the bandwidth master control node 140. Step 512 is shown in greater detail in FIG. 2. If step 512 is not successful 513, the process completes 515. Otherwise, the network node 140-142 announces 514 the network nodes 140-142 presence 140-142 on the logical network 145-146 and the process completes 515.

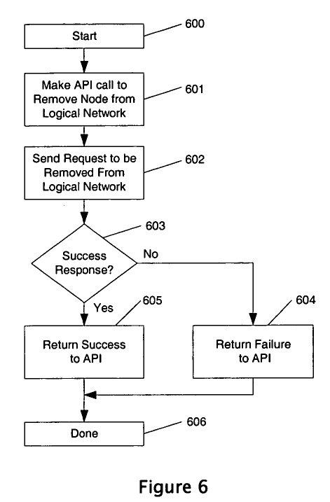

FIG. 6 is a flow diagram of the present preferred process for a network node 140-142 removing another network node 140-142 from a logical network 145-146. The process starts 600 when an Application Programming Interface (API) call is made 601 to remove a network node 140-142 from a logical network 145-146. A request to be removed from logical network packet 184 is sent 602 to the network node 140-142 which is being removed from the logical network 145-146. If the request from step 602 is received successfully 603, success is returned 605 to the API call made in step 601 and the process is complete 606. Otherwise, failure is returned 604 to the API call made in step 601 and the process is complete 606.

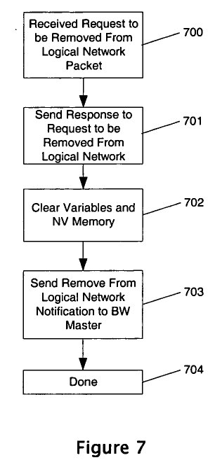

FIG. 7 is a flow diagram of the present preferred process for a network node 140-142 being removed from a logical network 145-146. The process begins when a network node 140-142 receives 700 a request to be removed from logical network packet 184 which was sent in step 602. The network node 140-142 sends 701 a response to the request to be removed from logical network packet 184 received in step 700. The network node 140-142 clears 702 out any variables and non-volatile memory that the network node 140-142 has been using. The network node 140-142 sends 703 a remove from logical network notification packet 185 to the bandwidth master control node 140 and is done 704.

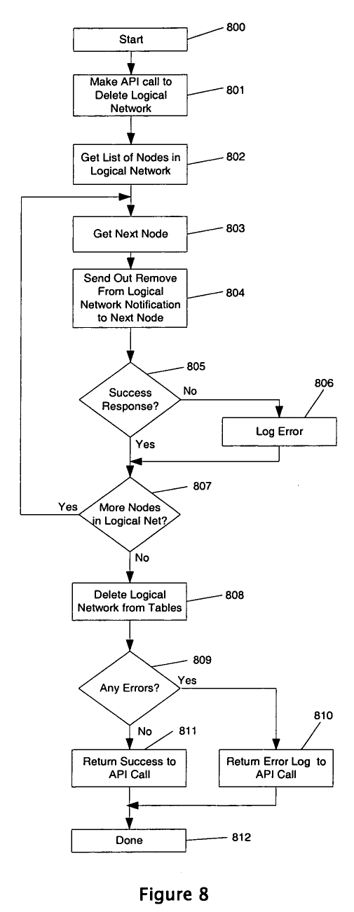

FIG. 8 is a flow diagram of the present preferred process for deleting a logical network 145-146. The process begins 800 when an API call is made 801 to delete a logical network 145-146. The process gets 802 a list of network nodes 140-142 which are part of a logical network 145-146 to use in deleting the logical network 145-146. The process gets 803 the next network node 140-142 to be removed from the logical network 145-146. The process sends 804 a remove from logical network notification packet 186 to the network node 140-142 being removed from the logical network 145-146. If a successful response is received in test 805, the process checks 807 for more network nodes 140-142 to be deleted from the logical network 145-146. Otherwise, the process logs 806 an error and checks 807 to see if there are more network nodes 140-142 to be deleted from the logical network 145-146. If in test 807 there are more network nodes 140-142 to be deleted from the logical network 145-146, the process gets 803 the next network node 140-142. Otherwise, the process deletes 808 the logical network 145-146 from the processes tables. If test 809 determines that there were any errors logged in step 806, the errors are returned 810 to the API call made in step 801 and the process completes 812. Otherwise, the process returns 811 success to the API call made in step 801 and completes 812.

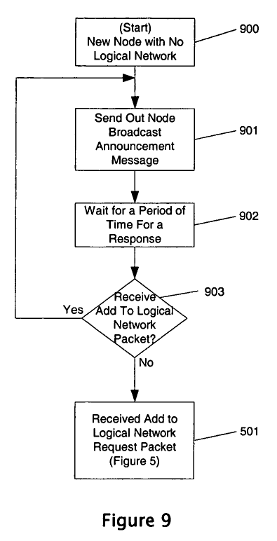

FIG. 9 is a flow diagram of the present preferred process for a network node 140-142 announcing it self so the network node 140-142 can be added to a logical network 145-146. The process begins when a network node 140-142 comes up 900 and has not been assigned to a logical network 145-146. The network node 140-142 sends 901 out a broadcast announcement message which announces itself to all network nodes 140-142 on the physical network 143. The network node 140-142 waits 902 for a period of time for a response to the broadcast announcement message. If the network node 140-142 receives in test 903 an add to logical network request packet 183 the process goes to step 501 in FIG. 5 where the network node 140-142 is added to the logical network 145-146. Otherwise, the process sends 901 out a broadcast packet to all network nodes 140-142 on the physical network 143.

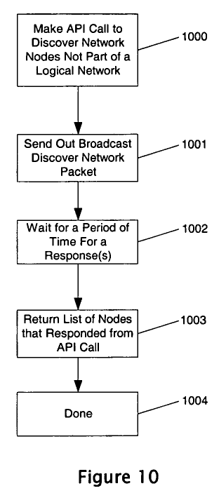

FIG. 10 is a flow diagram of the present preferred process for discovering network nodes 140-142 which are not assigned to a logical network 145-146. The process begins 1000 when an API call is made to discover network nodes 140-142 which are not assigned to a logical network 145-146. The process sends 1001 out a broadcast packet on the physical network 143 which requests network nodes 140-142 which are not part of the logical network 145-146 to respond. After waiting 1002 for a period of time for responses, the process returns 1003 the list network nodes 140-143 which responded to the broadcast packet to the API call made in step 1000. The process is complete 1004. The network nodes 140-142 which responded then can be added using the process described in FIG. 5.

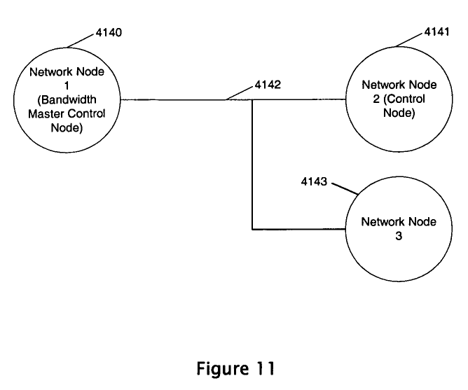

FIG. 11 is a diagram of the present preferred network for sending data segments between network nodes. In this document when referring to a network node in the singular, while referencing the single node with multiple nodes indicates that all referenced nodes can perform the same function as the single network node. A network 4142 is formed by plurality network nodes 4140 and 4141. One of the network nodes 4140 is a bandwidth master control node. Segments (packets) are sent across a time division multiplexed data mechanism which includes network 4142 which further includes time slots 4120-4136.

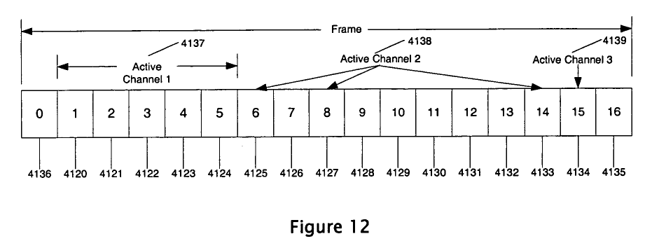

FIG. 12 is a diagram of the time division multiplexed data transfer mechanism of the present preferred embodiment of this invention used to transfer data on a network 4142. Transfer of data across a network 4142 occurs in two forms: packets which are broken up into segments and non-packet. Examples of data include but are not limited to voice, audio, control, video, and computer information and the like. A frame represents the bandwidth of the network 4142 over time and consists of a plurality of time slots 4120-4136. Time slots 4120-4136 in the present preferred embodiment are equal size pieces of Time Division Multiplexed (TDM) bandwidth which is used to transfer data over the AC power line or network 142. Each time slot is presently is 10 bits wide. The actual data sent presently is 32 bits with 22 bits used for forward error correction which results in 10 bits for each time slot. This is a 5/16 rate code. Time slot 4136 is used for frame synchronization across the network 4142 and time slots 4120-4135 are used for data transfer. Data is sent using active channels 4137-4139, which are pieces of network 4142 bandwidth. An active channel 4137-4139 is a variable or fixed size pipe made up of a single time slot or a plurality of time slots used to form a packet or non-packet pipe. For example, an active channel 4137 can be but is not limited to a group of contiguous slots 4120-4124. On the other hand, an active channel 4138 can consist of noncontiguous slots 4126, 4128, 4133. In addition, an active channel 4139 can include a single time slot 4134 or any number of time slots up to the maximum number of time slots in the frame. An active channel 4137-4139 is created by a bandwidth master control node 4140 which is a network node responsible for creating active channels 4137, 4138, and 4139 in conjunction with network nodes 4140, 4141, 4143 on a network 4142. Any network node can assume the role of bandwidth master control node 4140.

To transfer data between nodes, the user or application creates a Virtual Channel (VC) and creates an Active Channel (AC) 4137-4139. However, the virtual channel is not necessary if an active channel 4137-4139 does not need to be persistent. A virtual channel is a grouping of devices that eventually need to communicate with each other and can use the same service type. A service type is unique identifier that represents the type of data being transferred across a network 4142. Virtual channels contain persistent information about how to setup an active channel 4137-4139 when bandwidth is needed. Active channels 4137-4139 are created and destroyed by a network node 4140 that is responsible for bandwidth allocation called a bandwidth master control node 4140. A bandwidth master control node 4140 can control but is not limited to one or more distinct networks 4142 using the same physical medium by using a network number to identify each network 4142. An active channel 4139 is instantiated when a network node 4141 responsible for the active channel 4139 needs to create an active channel 4139, to pass data between network nodes 4140, 4141, 4143 in a active channel 4139. An active channel 4139 will typically exist only as long as the network nodes 4140, 4141 need bandwidth to transfer data while a virtual channel can exists permanently (or until the user or application no longer needs it). On the other hand, an active channel may stay up permanently if necessary. Virtual channels and active channels 4137-4139 are created via a signaling channel (which is an active channel) which is used to exchange information between nodes.

Once the network 4142 is created, virtual channels can be created. For example, virtual channels can be created for, but are not necessarily limited to Internet connections, alarm systems, appliances, home control systems, stereo systems, voice systems, and the like. This can occur from, but is not limited to an administrative console or an application going out and identifying which network nodes 4140, 4141 need to be apart of the virtual channel. A Virtual Channel Structure (VCS) is created which contains all the information necessary to create an active channel 4139. This allows network nodes 4140, 4141, 4143 to recreate an active channel 4139 that existed when power was lost on the network 4142. The virtual channel structure also keeps the network 4142 and the active channel 4139 secure by storing the encryption key information. The process is the same whether new network node 4141, 4142, 4143 is being added to an existing virtual channel or creating a new virtual channel.

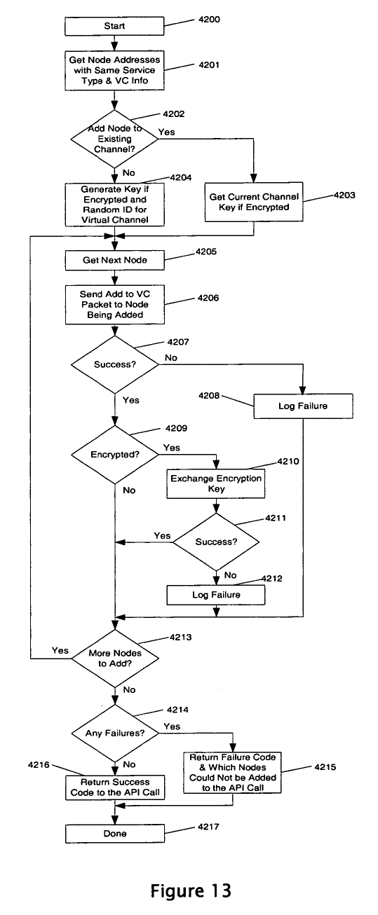

FIG. 13 is a flow diagram of the preferred virtual channel creation process from a network node 4141 which is requesting to create a virtual channel 4139. A request is made 4200 to create a virtual channel. The user or application generates 4201 a list of network nodes 4140, 4141, 4143 and the service type that are part of the virtual channel. This coupled with a virtual channel name is used to create an active channel 4139. At test 4202 the network node 4141 checks to see if an active channel 4139 already exists. If so, the application goes out and gets 4203 the existing encryption key for the virtual channel. Otherwise, the application generates 4204 a random key and ID for the virtual channel. The virtual channel name and the random ID are used to uniquely identify a virtual channel. In order to create a virtual channel, all network nodes 4140, 4141, 4143 that are part of the virtual channel should be able to communicate on the network 4142 or at a later period in time if being added to the virtual channel. If a network node 4140, 4141, 4143 was not a part of the initial virtual channel creation the network node 4140, 4141, 4143 will have to be added by a network node 4140, 4141, or 4143 that is already apart of the virtual channel in order to have a secure network. After getting 4205 the next network node 4140, 4141, or 4141 to be added, the packet to add the next node to the VC is sent 4206. The packet contains the virtual channel information except the encryption key. If test 4207 is not successful, an error is logged 4208. If test 4207 is successful, and if the active channel 4139 is to be encrypted 4209, the encryption key is passed 4210 using an encryption key passing algorithm. The present preferred embodiment uses Diffie-Hellman key exchange, but a variety of key exchange methods can be used. The encryption key is exchanged 4210. If test 4211 is successful, the process continues to see if more network nodes 4140, 4141, 4143 are to be added 4213. Otherwise, an error is logged 4212 for that network node 4140, 4141 or 4143. Test 4213 checks to see if there are other network nodes 4140, 4141 or 4143 to be added to the virtual channel. If so the process gets 4205 to be added to the virtual channel. Otherwise, there is a check 4214 for any failures. If there were any failures logged in step 4212, they are passed 4215 back to the Application Programming Interface (API). Each network node 4140, 4141, 4143 that failed to be added to the virtual channel and the reason why there was a failure is passed back 4215 to the API. If there were not any failures in test 4214, success is returned 4216 to the API. The process completes 4217.

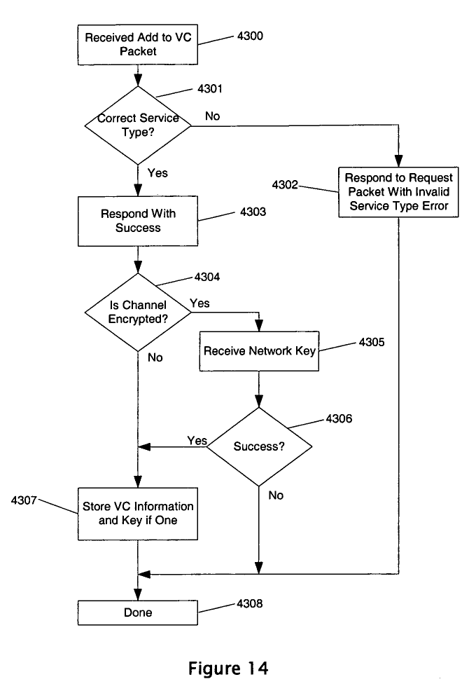

FIG. 14 is a flow diagram of the present preferred virtual channel creation process from the network node 4140, 4141, 4143 which is being requested to be apart of the virtual channel, wherein FIG. 13 is the flow diagram from the node creating the virtual channel. When a network node 4140, 4141, 4143 receives 4300 an “add to virtual channel packet”, the network node 4140, 4141, 4143 checks 4301 the service type to make sure that the service type matches its own service type. If there is not a match, the network node 4140, 4141, 4143 responds 4302 with an error packet. If there is a match in test 4301, the process responds 4303 with a success in the packet status. If the active channel 4139 is supposed to be encrypted in test 4304, the encryption key exchange process is used 4305 to exchange the virtual channel encryption key. If successful in test 4306, the key and the virtual channel information are stored 4307 and the process completes 4308. If the encryption key exchange fails in test 4306, the process completes 4308.

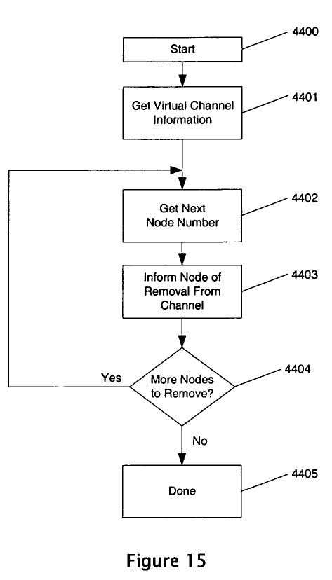

FIG. 15 is a flow diagram of the present preferred virtual channel removal process once an active channel 4139 is created. Under user or application control, a virtual channel can also be removed. Once the process is started 4400, a network node 4140, 4141, 4143 gets 4401 the virtual channel information. The algorithm goes through 4402 each network node that is part of the virtual channel 4140, 4141, 4143 in the list of network nodes 4140, 4141, 4143 and informs each network node 4140, 4141 or 4143 that is the network node 4140, 4141 or 4143 is being removed from the virtual channel at block 4403. The network node 4140, 4141 or 4143 deletes the virtual channel information. This process tests 4404 the next network node 4140, 4141, 4143 on the active channel 4139. If there is another network node 4140 or 4141 in test 4404, the process gets 4402 the next network node number. Otherwise, the process completes 4405. If a network node 4140, 4141 or 4143 cannot respond, the network node 4140, 4141, 4143 can to be removed later using the same process.

In the present preferred embodiment, here are two types of active channels that can be created: A control node active channel, and a peer active channel. A control node active channel is an active channel 4139 where there is one network node 4141 called a control node 4141 responsible for setting up and controlling an active channel 4139. A peer active channel is where network nodes 4140, 4141 can come and go and there is no central control node 4140, 4141 or 4143 responsible for creating an active channel 4139. The control node responsible for a control node active channel or any node responsible for a peer active channel can be any network node 4140 or 4141 on the network 4142 including the bandwidth master control node 4140. In a control node active channel, there is one network node 4141 that is responsible for creating, adding nodes to, and deleting nodes from an active channel 4139. If the control node 4141 is not active, the active channel 4139 cannot be established.

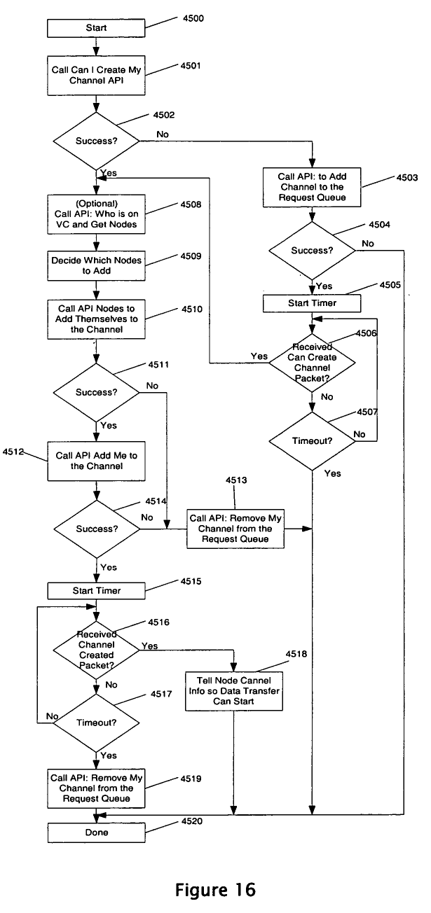

FIG. 16 is a flow diagram of the present preferred control node active channel creation process. First, the application starts 4500 by calling 4501 the “Can I Create My Channel” application programming interface that sends a packet to the bandwidth master control node 4140. The bandwidth master control node 4140 is responsible for creating virtual channels. If the response was not successful in test 4502 and the network node 4140, 4141, 4143 still wants the active channel 4139 to be created when resources are available, the network node 4140, 4141 or 4143 calls 4503 the application programming interface “Add Me to the Channel.” This application programming interface call puts the request into the request queue so that the bandwidth master control node 4140 can tell the network node 4140, 4141 or 4143 when an active channel 4139 can be created. If this successful in test 4504, a timer is started 4505 and the bandwidth master control node 4140 looks 4506 for the “You Can Create Your Channel” packet. If this packet is received the creation process optionally calls 4508 the API “who is on VC and get nodes.” Otherwise, the process times out 4507 and completes 4520. Once the network node 4140, 4141, or 4143 is informed that the active channel 4139 can be created in test 4502 or test 4506, the network node 4140, 4141, or 4143 goes and determines 4508 which network nodes 4140, 4141, or 4143 are on the active channel 4139 if the network node 4140, 4141, 4143 doesn't know already. The network node 4140, 4141, 4143 decides 4509 which network nodes 4140, 4141, 4143 need to be apart of the active channel 4139 if the network node 4140 or 4141 did not know earlier. The application calls 4510 the Application Programming Interface to Tell a Node to Add Itself to the Channel. When a network node 4140, 4141, 4143 receives a request to add the network node 4140, 4141 or 4143 to an active channel 4139, the network node 4140, 4141, or 4143 informs the bandwidth master control node 4140 and requests that the network node 4140, 4141 or 4143 be added to the active channel 4139. If this is successful, the process responds 4510 to the Tell a Node to Add Itself to the Channel message. If test 4511 was not successful, the control node 4141 calls 4513 the “Remove My Channel from the Request Queue” application programming interface which ends the Active Channel creation. Otherwise, the control node 4141 will add 4512 the control node 4141 to the active channel 4139. If there is a failure in test 4514, the control node 4141 calls 4513 the “Remove My Channel from the Request Queue” application programming interface. Otherwise, the control node 4141 starts 4515 a timer and waits for the packet that indicates that the active channel 4139 was created. Once control node 4141 receives 4516 the packet that indicates the active channel 4139 was created, the control node 4141 tells 4518 all the network nodes 4140, 4141, 4143 using the active channel 4139 the information necessary to use the active channel 4139 and completes the process 4520. If the timer expires in test 4517, the control node 4141 calls 4519 the “Remove My Channel from the Request Queue”application programming interface to remove the request and the process completes 4520.

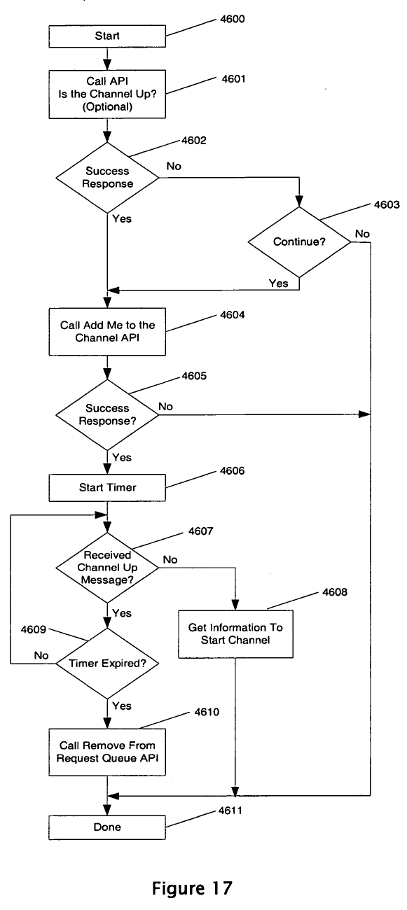

For peer networks, the process happens differently. This is because in a peer network, any network node 4140 or group of network nodes 4140, 4141, 4143 can be up at any time. For this reason, any network node 4140, 4141, 4143 can initiate the process that creates an active channel 4139. A network node 4140, 4141 or 4143 can request to be added to an active channel 4139, but an active channel 4139 will not be created until at least two network nodes 4140, 4141 have requested to be added to the active channel 4139. FIG. 17 is a flow diagram of the present preferred active channel 4139 creation process for a peer active channel. On a peer active channel, a network node 4140 or 4141 can optionally go out 4600 and see if the active channel 4139 is up 4601. In test 4602 if the response is unsuccessful, the network node 4140, 4141, 4143 can decide if the network node 4140, 4141, 4143 wants to continue in test 4603 or quit. If the network node 4140, 4141, 4143 wants to quit, the process completes 4611. If the network node 4140, 4141, 4143 wants to continue, network node 4140, 4141, 4143 calls 4604 the Application Programming Interface Add Me to a Channel. Step 4604 is also called if test 4602 is successful. If test 4605 is unsuccessful the process completes 4611. Otherwise, if test 4605 is successful, the network node 4140, 4141 or 4143 starts a timer 4606 in which the network node 4140, 4141 or 4143 looks 4607 for the channel is up packet. If the network node 4140, 4141, 4143 receives this message the network node 4140, 4141, 4143 joins 4608 the active channel 4139 and the process completes 4611. Otherwise, if there is a timeout 4609, the network node 4140, 4141, 4143 removes 4610 the network node's 4140, 4141, 4143 request to be added from the request queue and ends the process 4611. This process works the same for a network node 4140, 4141 or 4143 being added after an active channel 4139 is up. To remove an active channel 4139, a network node 4140, 4141 or 4143 can call the remove a channel API. The bandwidth master control node 4140 will inform each network node 4140, 4141, 4143 that is currently apart of the active channel 4139 that the active channel 4139 is being torn down.

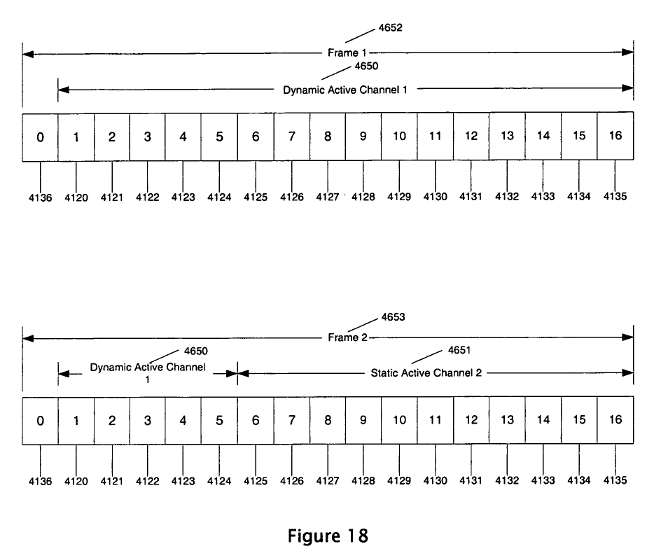

FIG. 18 is a diagram of the present preferred dynamic active channel resizing. When a dynamic active channel 4650 is created, there are two fields: The minimum bandwidth value and maximum bandwidth value. These fields are used by the bandwidth master control node 4140 to create dynamic active channels 4650 that can be increased or decreased based on available bandwidth. Active channels can be either static active channels 4651 or dynamic active channels 4650. A dynamic active channel 4650 is one where the dynamic active channel's 4650 size (the number of time slots 4120-4135 the active channel 4650 uses) can change dynamically and a static active channel 4651 will always require the same number of time slots 4125-4135 in this example. FIG. 18 depicts a static active channel 4651 that uses 11 time slots 4125-4135. The size of a static active channel 4651 can be any size from one time slot to the maximum number of time slots 4120-4135 that the system uses. A dynamic active channel 4650 can be resized on the fly down to the minimum bandwidth value or up to the maximum bandwidth value. The minimum bandwidth field and maximum bandwidth fields will be the same for a static active channel 4651. These fields are coupled with the bandwidth priority value are used to track the priority of the dynamic active channel 4650 or static active channel 4651 and whether the channel is a static active channel 4651 or a dynamic active channel 4650. The preferred embodiment uses the following four priorities: 1. Guaranteed Priority, 2. High Priority, 3. Normal Priority, and 4. Low Priority. Bandwidth is allocated on a priority basis, thus allowing a higher priority dynamic active channels 4650 or static active channels 4651 to take bandwidth from lower priority channels. When a dynamic active channel 4650 is first created the dynamic active channel 4650 takes all free time slots up to the maximum bandwidth value. Dynamic active channel one 4650 has a minimum bandwidth value of one and a maximum bandwidth value of fifteen. Frame one 4652 shows dynamic channel one 4650 taking all time slots 4120-4135 when dynamic active channel one 4650 is first created on an unused network 4142. When a new channel is created (static or dynamic) bandwidth is taken from dynamic channels 4650. For example, if after dynamic active channel one 4650 is created, the dynamic active channel one 4650 is dropped in frame two 4653 to 5 time slots 4120-4124 as a new static active channel one 4651 is created even if static active channel one 4651 is a lower priority. The minimum bandwidth value and the maximum bandwidth values are only limited by the number of time slots 4120-4135 available. Once there are no dynamic slots available, active channels are created or deleted based on priority. Priority is not limited to but in the present preferred embodiment is on a first come first serve basis. This means that a new active channel cannot be created if all the slots are allocated by active channels at the same or higher priority.

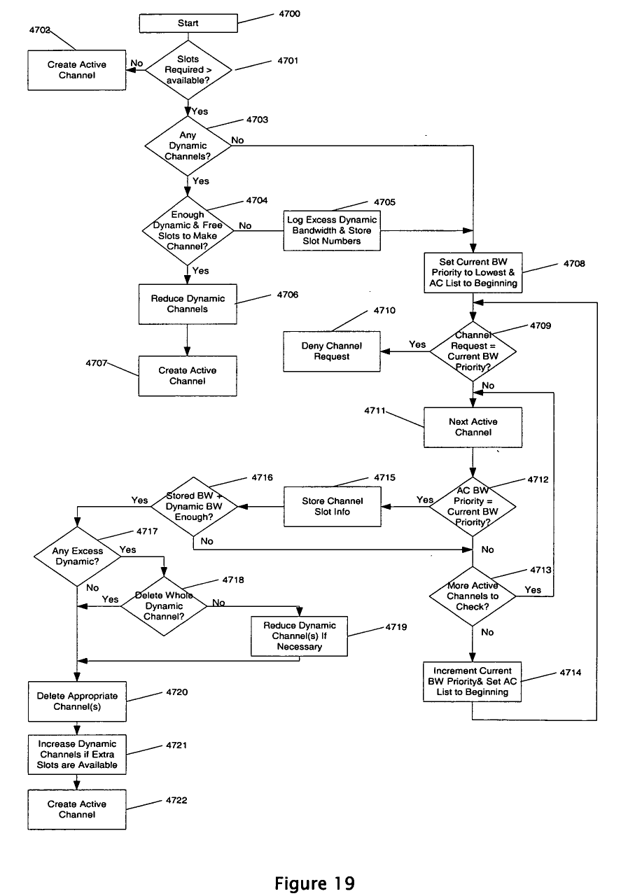

FIG. 19 is a flow diagram of the preferred process for bandwidth allocation using channel priorities. Once a new active channel 4651 needs to be created 4700, the bandwidth master control node 4140 first looks 4701 to see if there are enough free time slots 4120-4135 to create the new active channel 4651. An active channel 4651 will be created if there are at least enough free time slots 4120-4135 to meet the minimum bandwidth value. If so, the new active channel 4651 is created 4702. Otherwise, the bandwidth master control node 4140 looks 4703 to see if there are any dynamic active channels 4650. The process checks 4704 to see if there are enough dynamic and free time slots 4120-4135 to create the new active channel 4651. If the process determines that the dynamic channels 4650 have enough excess bandwidth (the difference between the minimum bandwidth value and the current size of the dynamic active channel 4650) to create the new active channel 4651, the dynamic active channel(s) 4650 size is reduced 4706 and the new active channel 4651 is created 4707. If the time slots 4120-4125 to create the new active channel 4651 are coming from multiple dynamic active channels 4650, the time slots 4120-4135 used come from the lowest priority dynamic active channel 4650 first in the present preferred embodiment. If the active channels are at the same priority, the process is done (but not required to) on a first come first serve basis. If there are not enough excess dynamic time slots 4120-4135 available 4704, the time slots 4120-4135 are logged 4705 and stored for use later. If there is not enough bandwidth at steps 4703 or 4705, the current bandwidth priority value is set 4708 to the lowest priority. The current bandwidth priority value is used to search through the active channel list for priorities that match it. The active channel list is set 4708 to point to the beginning of the list of active channels. The request to build the new active channel 4651 is checked 4709 to see if the new active channel 4651 is at the current search bandwidth priority. If so, a deny channel packet is sent 4710 to the control node 4141 and the process ends. Otherwise, the channel search process continues by getting 4711 the next active channel from the list. The current active channel's bandwidth priority is compared 4712 to the current search bandwidth priority. If a match is not found, the process tests 4713 to see if there are more active channels in the list. If there are more active channels in the list to check 4713, the process gets the next active channel in the list 4711. Otherwise if test 4713 is no, the active channel list search pointer is set 4714 back to the beginning, the current bandwidth priority is incremented, and the process checks to see if the new channel request is equal 4709 to the current bandwidth priority. When an active channel is found that is at a lower bandwidth priority than the new active channel 4651 and is at the current search bandwidth priority in test 4712, the information is stored 4715. This information along with the slot information of any excess dynamic channel slots 4120-4135 from step 4705 and any previous lower priority time slots 4120-4135 are checked 4716 to see if there are enough time slots 4120-4135 to make the new active channel 4651. If not, the process returns to the channel search process and checks 4713 to see if there are more active channels in the list. Otherwise, the process of creating the new active channel 4651 begins. If there are excess dynamic slots available 4717, the bandwidth master control node 4140 checks to see if the whole dynamic active channel 4650 to which the excess dynamic time slots 4120-4135 are tied needs to be deleted 4718. If not, the dynamic active channel's 4650 size is reduced 4719 if necessary. It may not be necessary to reduce the active dynamic channel 4650 if the excess dynamic time slots 4120-4135 are not great enough to be used in the new active channel 4651 in step 4719. The necessary channel or channels are deleted 4720. If there are any excess slots that can be used in dynamic channels 4650, the excess slots are reassigned 4721 to the appropriate channel or channels. Finally, the new active channel 4650 is created 4722.

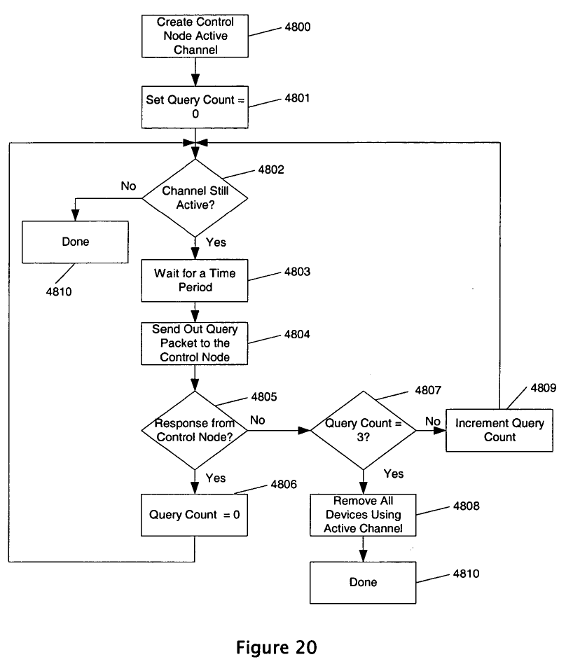

FIG. 20 is a flow diagram of the present preferred process for bandwidth reclamation in a control node active channel. The process begins when a control node active channel is created 4800 on the bandwidth master control node 4140. The control node active channel has a control node 4141 and a network node 4143 that use the control node active channel. The query count is then set 4801 to zero. The process then tests 4802 to see if the control node active channel is still active. If not the process is done 4810. Otherwise, if the control node active channel is still active 4802, the process waits 4803 for a period of time. The process sends 4804 out a query packet to the control node 4141. If a response to the query packet is received in test 4805 from the control node 4141, the query count is set 4806 to zero and the process tests 4802 to see if the control node active channel is still active. Otherwise, if there is no response from the control node 4141 in test 4805, the query count is checked 4807 to see if it is three. In the present preferred embodiment, the query count is three, but this value could be dynamic or another value as the needs of the system require. If the query count is three 4807, all network nodes 4141, 4143 using the control node active channel are removed 4808 from the control node active channel by sending remove from channel packets to each network node using the control node active channel and the process is done 4810. Otherwise, if the query count is not three in test 4807, the process increments 4809 the query count and checks 4802 to see if the control node active channel is still active.

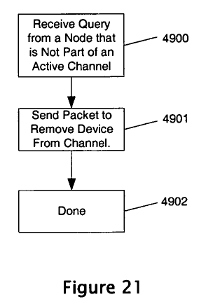

FIG. 21 is a flow diagram of the present preferred process for notifying network nodes that the network node is no longer part of an active channel. When a control node 4141 or a network node 4143 cannot see query packets from the bandwidth control node master 4140 for reasons such as network noise and the like, these network nodes may have been removed from an active channel without being informed. If a network node 4141, 4143 cannot see the bandwidth master control node 4140; the network nodes 4141, 4143 send query packets to the bandwidth master control node 4140. If the bandwidth master control node 4140 receives 4900 a query from a network node 4140 or a control node 4141 and that node is no longer apart of the active channel associated with the query, the bandwidth master control node 4140 will then send 4901 a packet to remove network node 4140 or 4141 from the active channel. The process is then done 4902.

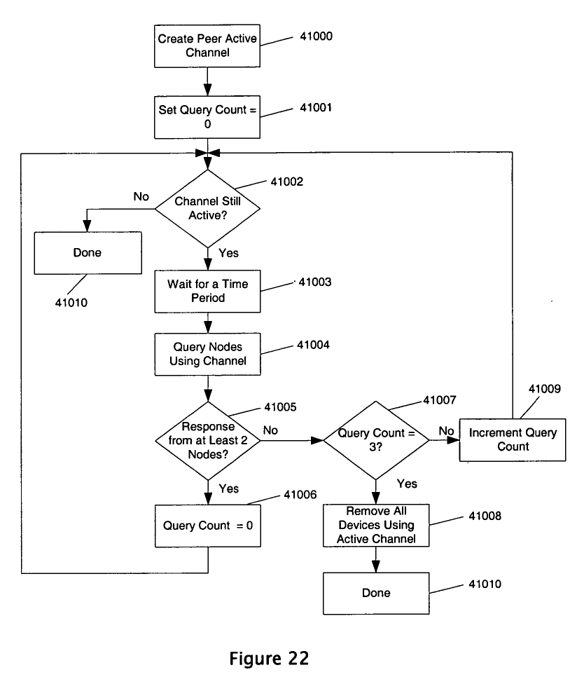

FIG. 22 is a diagram of the present preferred process for bandwidth reclamation in a peer active channel. The process begins when a peer active channel is created 41000 on the bandwidth master control node 4140 where the peer channel has two network nodes 4141, 4143 that use the peer channel. The query count is then set 41001 to zero. The process then tests 41002 to see if the peer active channel is still active. If not the process is done 41010. Otherwise, if the peer active channel is still active 41002, the process waits 41003 for a period of time. The process sends 41004 out query packets to network nodes 4141, 4143 on the peer active channel until at least two network nodes 4141, 4143 respond or all network nodes have been queried. If a response to at least two of the query packets is received in test 41005, the query count is set 41006 to zero and the process tests 41002 to see if the peer active channel is still active. Otherwise, if there is no response from at least two network nodes 4141 and 4143 in test 41005, the query count is checked 41007 to see if it is three. In the present preferred embodiment, the query count is three, but this value could be dynamic or another value as the needs of the system require. If the query count is three 41007, all the network nodes 4141, 4143 using the peer active channel are removed 41008 from the peer active channel by sending remove from channel packets to each network node 4141, 4143 using the peer active channel and the process is done 41010. Otherwise, if the query count is not three in test 41007, the process increments 41009 the query count and checks 41002 to see if the peer active channel is still active.

Since these logical network methods and systems are designed to be physical layer independent, these logical network methods and systems will run over a wide variety of networks, including but are not limited to such types of networks as AC power line, DC power line, light frequency (fiber, light, or the like), Radio Frequency (RF) networks (wireless such 802.11b, infrared, or the like), acoustic, and wired (coax, twisted pair, or the like).

In addition, these data transportation methods and systems can be implemented using a variety of processes, including but are not limited to computer hardware, microcode, firmware, software, or the like.

The described embodiments of this invention are to be considered in all respects only as illustrative and not as restrictive. Although specific flow diagrams and packet formats are provided, the invention is not limited thereto. The scope of this invention is, therefore, indicated by the claims rather than the foregoing description. All changes, which come within the meaning and range of equivalency of the claims, are to be embraced within their scope.

1. A method for creating a logical network comprising:
A. creating a request to create a logical network packet wherein said request to create a logical network packet comprises a logical network name and a logical network number;
B. sending said request to create a logical network packet to a bandwidth master control node;
C. receiving said request to create a logical network packet on said bandwidth master control node; and
D. determining if a logical network will be created.

2. A method for creating a logical network as recited in claim 1 further comprising the step of creating an active channel.

3. A method for creating a logical network as recited in claim 2, further comprising the steps of:
A. informing one or more network nodes of the creation of a logical network by said bandwidth master control node by passing parameters to said one or more network nodes for joining said logical network; and
B. joining said logical network by said one or more network nodes.

4. A method for creating a logical network as recited in claim 3, further comprising the step of encrypting said logical network.

5. A method for creating a logical network as recited in claim 3, further comprising the step of joining a second logical network by said one or more network nodes.

6. A method for creating a logical network as recited in claim 2, further comprising the step of denying said request to create a logical network.

7. A method for creating a logical network as recited in claim 2, wherein creating said request to create a logical network further comprises creating said request to create a logical network wherein said network number is generated randomly.

8. A method for creating a logical network as recited in claim 2, wherein sending said request to create a logical network further comprises sending said request to create a logical network on a physical network selected from the group consisting of a power line network, a wireless network, a light frequency network, an acoustic network, and a wired network.

9. A method for logical address assignment on a network comprising:
A. building a request for a logical address packet on a network node wherein said request for a logical address packet further comprises a logical network name, a logical network number, and a network node address;
B. sending said request for a logical address packet to a bandwidth master control node;
C. receiving said request for a logical address packet on said bandwidth master control node;
D. determining if said logical network name and said logical network number identifies a logical network; and
E. determining if said network node address is part of said logical network.

10. A method for logical address assignment on a network as recited in claim 9, further comprising the step of creating an active channel.

11. A method for logical address assignment on a network as recited in claim 10, further comprising the step of sending to said network node a logical address.

12. A method for logical address assignment on a network as recited in claim 10, further comprising the steps of:
A. adding said node address to said logical network; and
B. sending to said network node a logical address.

13. A method for logical address assignment on a network as recited in claim 10, wherein sending said request for a logical address packet further comprises sending said request for a logical address packet on a physical network selected from the group consisting of a power line network, a wireless network, a light frequency network, an acoustic network, and a wired network.

14. A method for logical address aging on a network comprising:
A. sending a query logical node packet to one or more network nodes on a logical network;
B. determining if said one or more network nodes responded to said query logical node packet; and
C. deciding if said one or more network nodes should be removed from said logical network.

15. A method for logical address aging on a network as recited in claim 14, further comprising the step creating an active channel.

16. A method for logical address aging on a network as recited in claim 15, further comprising the step of removing said one or more network nodes from said logical network.

17. A method for logical address aging on a network as recited in claim 15, further comprising the step of keeping said one or more network nodes a part of said logical network.

18. A method for logical address aging on a network as recited in claim 15, wherein sending said query logical node packet further comprises sending said query logical node packet on a physical network selected from the group consisting of a power line network, a wireless network, a light frequency network, an acoustic network, and a wired network.

19. A method for adding network nodes to a logical network comprising:
A. building an add to logical network request packet on a first network node which is part of a logical network;
B. sending said add to logical network request packet to a second network node;
C. receiving said add to logical network request packet on said second network node;
D. determining if said second network node should be added to said logical network; and
E. adding said second network node to said logical network.

20. A method for adding network nodes to a logical network as recited in claim 19 further comprising the step of creating an active channel.

21. A method for adding network nodes to a logical network as recited in claim 20 further comprising the step of encrypting said logical network.

22. A method for logical address aging on a network as recited in claim 20, wherein sending said add to logical network request packet further comprises sending said add to logical network request packet on a physical network selected from the group consisting of a power line network, a wireless network, a light frequency network, an acoustic network, and a wired network.

23. A method for removing network nodes from a logical network comprising:
A. making a request to be removed from a logical network packet on a first network node;
B. sending said request to be removed from a logical network packet to a second network node; and
C. removing said first network node from said logical network.

24. A method for removing network nodes from a logical network as recited in claim 23, further comprising the step of creating an active channel.

25. A method for removing network nodes from a logical network as recited in claim 24, further comprising the step of sending a remove from logical network notification packet to said first network node.

26. A method for removing network nodes from a logical network as recited in claim 25 further comprising the step of sending an acknowledgement from said second network node in response said remove from logical network notification.

27. A method for removing network nodes from a logical network as recited in claim 24, wherein sending said request to be removed from a logical network packet further comprises sending said request to be removed from a logical network packet on a physical network selected from the group consisting of a power line network, a wireless network, a light frequency network, an acoustic network, and a wired network.

28. A method for deleting a logical network comprising:
A. getting a list of network nodes on a logical network;
B. sending a request to be removed from logical network packet to each network node in said list of network nodes;
C. waiting for a response from each network node in said list of network nodes;
D. removing said network node from said logical network; and
E. removing said logical network.

29. A method for deleting a logical network as recited in claim 28, further comprising the step of creating an active channel.

30. A method for deleting a logical network as recited in claim 29, wherein sending said request to be removed from logical network packet further comprises sending said request to be removed from a logical network packet on a physical network selected from the group consisting of a power line network, a wireless network, a light frequency network, an acoustic network, and a wired network.

31. A method detecting network nodes on a logical network comprising:
A. sending out a broadcast announcement message from a first network node on a physical network wherein said broadcast announcement message notifies one or more network nodes of said first network node's presence on said physical network;
B. waiting for one or more responses from said one or more network nodes; and
C. adding said first network node to a logical network.

32. A method detecting network nodes on a logical network as recited in claim 31, further comprising the step of creating an active channel.

33. A method detecting network nodes on a logical network as recited in claim 32, wherein sending said broadcast announcement message further comprises sending said broadcast announcement message on a physical network selected from the group consisting of a power line network, a wireless network, a light frequency network, an acoustic network, and a wired network.

34. A method detecting network nodes on a logical network comprising:
A. sending out a broadcast discover network packet on a physical network from a first network node wherein said broadcast discover network packet requests network nodes which are not part of a logical network to respond;
B. waiting for responses from said network nodes; and
C. adding said first network node to said logical network.

35. A method detecting network nodes on a logical network as recited in claim 34, further comprising the step of creating an active channel.

36. A method detecting network nodes on a logical network as recited in claim 35, wherein sending said broadcast network discover packet further comprises sending said broadcast network discover packet on a physical network selected from the group consisting of a power line network, a wireless network, a light frequency network, an acoustic network, and a wired network.

37. A system for creating a logical network comprising:
A. a plurality of network nodes forming a physical network;
B. wherein said plurality of network nodes further comprises a bandwidth master control node;
C. wherein said at least one of said plurality of network nodes sends a request to create a logical network packet on said physical network wherein said request to create a logical network packet comprises a logical network name and a logical network number and wherein said request to create a logical network packet is sent to said bandwidth master control node; and
D. wherein said bandwidth master control node upon receiving said request to create a logical network packet determines if a logical network will be created.

38. A system for creating a logical network as recited in claim 37, wherein one of said plurality of network nodes creates an active channel.

39. A system for creating a logical network as recited in claim 37, wherein said bandwidth master control informs at least one of said plurality of network nodes of the creation of said logical network by passing parameters to at least one of said plurality of network nodes and wherein at least one of said plurality of network nodes joins said logical network.

40. A system for creating a logical network as recited in claim 39, wherein said logical network is encrypted.

41. A system for creating a logical network as recited in claim 39, wherein at least one of said plurality of network nodes joins a second logical network.

42. A system for creating a logical network as recited in claim 37, wherein said bandwidth master control node fails to create said logical network.

43. A system for creating a logical network as recited in claim 37, wherein said network number is generated randomly.

44. A system for creating a logical network as recited in claim 37, wherein said physical network is a physical network selected from the group consisting of a power line network, a wireless network, a light frequency network, an acoustic network, and a wired network.

45. A system for logical address assignment on a network comprising:
A. a plurality of network nodes forming a physical network;
B. wherein said plurality of network nodes further comprises a bandwidth master control node;
C. wherein said at least one of said plurality of network nodes sends a request for a logical address packet which further comprises a logical network name, a logical network number, and a network node address, and wherein said request for a logical network number packet is sent to said bandwidth master control node; and
D. wherein said bandwidth master control node upon receiving said request for a logical address packet determines if said logical network name and said logical network number identify a logical network; and
E. wherein said bandwidth master control node determines if said network node address is part of said logical network;

46. A system for logical address assignment on a network recited in claim 45, wherein one of said plurality of network nodes creates an active channel.

47. A system for logical address assignment on a network as recited in claim 45, wherein said bandwidth master control node sends said network node a logical address.

48. A system for logical address assignment on a network as recited in claim 45, wherein said bandwidth master control node adds said node address to said logical network and sends to said network node a logical address.

49. A system for logical address assignment on a network as recited in claim 45, wherein said physical network further comprises a physical network selected from the group consisting of a power line network, a wireless network, a light frequency network, an acoustic network and a wired network.

50. A system for logical address aging on a network comprising:
A. a plurality of network nodes forming a physical network wherein said physical network further comprises a logical network;
B. wherein said plurality of network nodes further comprises a bandwidth master control node;
C. wherein said bandwidth master control node sends a query logical node packet to one or more of said plurality of network nodes on said logical network;
D. wherein said bandwidth master control node determines if any of said plurality of network nodes responded to said query logical node packet; and
E. wherein said bandwidth master control node determines which of said plurality of network nodes should be removed from said logical network.

51. A system for logical address aging on a network as recited in claim 50, wherein one of said plurality of network nodes creates an active channel.

52. A system for logical address aging on a network as recited in claim 50, wherein said bandwidth master control node removes at least one of said plurality of network nodes from said logical network.

53. A system for logical address aging on a network as recited in claim 50, wherein said bandwidth master control node removes zero of said plurality of network nodes from said logical network.

54. A system for logical address aging on a network as recited in claim 50, wherein said physical network further comprises a physical network selected from the group consisting of a power line network, a wireless network, a light frequency network, an acoustic network, and a wired network.

55. A system for adding network nodes to a logical network comprising:
A. a plurality of network nodes forming a physical network wherein said physical network further comprises a logical network;
B. wherein said plurality of network nodes further comprises a first network node and a second network node;
C. wherein said first network node builds an add to logical network request packet;
D. wherein said first network node sends said an add to logical network request packet to said second network node;
E. wherein said second network node determines if said second network node will be added to said logical network; and
F. wherein said second network node is added to said logical network.

56. A system for adding network nodes to a logical network as recited in claim 55, wherein one of said plurality of network nodes creates an active channel.

57. A system for adding network nodes to a logical network as recited in claim 55, wherein said logical network is encrypted.

58. A system for adding network nodes to a logical network as recited in claim 55, wherein said physical network further comprises a physical network selected from the group consisting of a power line network, a wireless network, a light frequency network, an acoustic network, and a wired network.

59. A system for removing network nodes from a logical network comprising:
A. a plurality of network nodes forming a physical network wherein said physical network further comprises a logical network;
B. wherein said plurality of network nodes further comprises a first network node and a second network node;
C. wherein said first network node which is part of said logical network makes a request to be removed from logical network packet wherein said request to be removed from logical network packet is sent to said second network node; and
D. wherein said first network node is removed from said logical network.

60. A system for removing network nodes from a logical network as recited in claim 59, wherein one of said plurality of network nodes creates an active channel.

61. A system for removing network nodes from a logical network as recited in claim 59, wherein said second network node sends a remove from logical network notification packet to said first network node.

62. A system for removing network nodes from a logical network as recited in claim 61, wherein said first node sends an acknowledgement in response said remove from logical network notification.

63. A system for removing network nodes from a logical network as recited in claim 59, wherein said physical network further comprises a physical network selected from the group consisting of a power line network, a wireless network, a light frequency network, an acoustic network, and a wired network.

64. A system for deleting a logical network comprising:
A. a plurality of network nodes forming a physical network wherein said physical network further comprises a logical network;
B. wherein said plurality of network nodes further comprises one or more network nodes which are part of said logical network.
C. wherein said one or more network nodes which are part of said logical network sends a removed from logical network notification packet to each of said one or more network nodes which are part of said logical network; and
D. Wherein each of said one or more network nodes which are part of said logical network are removed from said logical network.

65. A system for deleting a logical network as recited in claim 64, wherein one or more of said plurality of network nodes creates an active channel.

66. A system for deleting a logical network as recited in claim 64, wherein said physical network further comprises a physical network selected from the group consisting of a power line network, a wireless network, a light frequency network, an acoustic network, and a wired network.

67. A system detecting network nodes on a logical network comprising:
A. a plurality of network nodes forming a physical network wherein said physical network further comprises a logical network;
B. wherein said plurality of network nodes further comprises a first network node first network node which is part of said logical network;
C. wherein said plurality of network nodes further comprises a second network node which is not part of said logical network;
D. wherein said second network node sends out a broadcast announcement message on said physical network; and
E. wherein said first node responds to said broadcast announcement message by adding said second node to said logical network.

68. A system detecting network nodes on a logical network as recited in claim 67, wherein one or more of said plurality of network nodes creates an active channel.

69. A system detecting network nodes on a logical network as recited in claim 68, wherein said physical network further comprises a physical network selected from the group consisting of a power line network, a wireless network, a light frequency network, an acoustic network, and a wired network.

70. A system detecting network nodes on a logical network comprising:
A. a plurality of network nodes forming a physical network wherein said physical network further comprises a logical network;
B. wherein said plurality of network nodes further comprises a first network node which is part of said logical network;
C. wherein said plurality of network nodes further comprises a second network node which is not part of said logical network;
D. wherein said first network node sends out a broadcast discover network packet on said physical network; and
E. wherein said second node responds to said broadcast discover network packet by adding said second node to said logical network.

71. A system detecting network nodes on a logical network as recited in claim 70, wherein one or more of said plurality of network nodes creates an active channel.

72. A system detecting network nodes on a logical network as recited in claim 71, wherein said physical network further comprises a physical network selected from the group consisting of a power line network, a wireless network, a light frequency network, an acoustic network, and a wired network.
